(19) United States
(12) Patent Application Publication
(10) Pub. No.: US 2020/0286133 A1
(43) Pub. Date: Sep. 10, 2020

(54) HIERARCHICAL PROXY POWER SYSTEM FOR ADMINISTRATION OF CHARITABLE TRUST

(71) Applicant: Bank of America Corporation, Charlotte, NC (US)

(72) Inventor: Manu Kurian, Dallas, TX (US)

(21) Appl. No.: 16/291,151

(22) Filed: Mar. 4, 2019

(51) Int. Cl. G06Q 30/02; G06Q 20/06; H04L 9/06

(52) U.S. Cl. CPC G06Q 30/0279; H04L 9/0637; G06Q 20/065

(57) ABSTRACT

Systems and methods for tracking and controlling the flow of funds in a digital donation platform are provided. The platform may receive a plurality of donation transmissions from a plurality of donors. Each donation transmission may be associated with a target charitable category. Each donation transmission may be converted into a plurality of data points that may be stored on a blockchain database. The platform may include a plurality of digital portals, each portal associated with a donor and configured to provide the donor access to the platform. Each portal may be configured with an access profile that may define a level of access to provide to the associated donor. The platform may be configured with a dynamically scalable hierarchical architecture, wherein donors are enabled to adjust the level of access for their own portals and/or the portals of other donors in the platform.

### CROSS REFERENCE TO RELATED APPLICATION

Co-pending, commonly assigned U.S. patent application entitled “DONOR AND RECIPIENT AUTHENTIC AUTHORIZATION,” having application Ser. No. 16/276,694, and filed on Feb. 15, 2019, is hereby incorporated by reference herein in its entirety.

### FIELD OF TECHNOLOGY

Aspects of the disclosure relate to digital platforms. Specifically, aspects of the disclosure relate to digital platforms for administering charitable donations.

### BACKGROUND OF THE DISCLOSURE

Many charitable donation entities use online platforms to streamline the donation process. Online donation platforms reduce the need for inefficient telephone, mail, and in-person communication. Transmitting funds via online platforms may enable needy charity organizations to receive donations almost instantaneously. Because of the ease of using online donation platforms to contribute to charity, donors may be motivated and encouraged to donate more frequently.

On the other hand, however, donors to an online donation platform may feel removed from the administration of the charitable funds. The donors may have concerns about their donations reaching any legitimate charitable cause, let alone a specific charitable cause of their choice.

It would be desirable, therefore, to provide systems and methods that enable donors to track and control the flow of donation funds in digital donation platforms. Some donors, however, may not have the time or ability to track and control the funds for themselves. It would be further desirable, therefore, to provide the ability to adjust the platform to enable proxy tracking and control.

### SUMMARY OF THE DISCLOSURE

Aspects of the disclosure relate to a charitable donation platform. The platform may include a blockchain database. The blockchain database may be configured to store a plurality of donations received from a plurality of donors. Each donation may include a monetary value. Each donation may also be associated with a target charitable category. The donor may select the target charitable category for the donation.

The platform may also include a plurality of digital portals. Each digital portal may be associated with a donor. The digital portal of a donor may be configured to provide the donor with access to the platform.

The platform may be configured with a hierarchical architecture. The hierarchical architecture may include multiple tiers of the one or more digital portals. A first tier of digital portals may be configured to provide visibility access. Visibility access may provide access to view data stored in the blockchain database. A second tier of digital portals may be configured to provide authorization access. Authorization access may provide access to authorize transactions on the platform.

The platform may be further configured to identify a charitable cause. The platform may also be configured to determine a monetary amount and a charitable category for association with the charitable cause.

The platform may be configured to structure a transaction. Structuring a transaction may include compiling a set of donations for the charitable cause. The set of donations may include one or more donations associated with target charitable categories that match the charitable category of the charitable cause. The sum of the monetary values of the one or more donations in the set of donations may equal at least the monetary amount.

The transaction may be authorized via one or more of the second tier of digital portals. When the transaction is authorized, the platform may be configured to transfer funds from the donations in the set of donations to the charitable cause. The platform may also be configured to update the blockchain database to record the transfer.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative apparatus in accordance with principles of the disclosure;

FIG. 3 shows an illustrative architecture in accordance with principles of the disclosure;

FIG. 4 shows an illustrative diagram in accordance with principles of the disclosure;

FIG. 5 shows another illustrative diagram in accordance with principles of the disclosure;

FIG. 6 shows an illustrative flowchart in accordance with principles of the disclosure;

FIG. 7 shows an illustrative screenshot in accordance with principles of the disclosure; and

FIG. 8 shows another illustrative screenshot in accordance with principles of the disclosure.

### DETAILED DESCRIPTION OF THE DISCLOSURE

A charitable donation platform is provided. The platform may be a digital platform that includes computer executable instructions that are stored in non-transitory memory and run on a processor. The platform may run on a server. The platform may run on a “cloud.” The platform may be accessible, online or via any suitable network, by other remote servers or computing devices.

The platform may include a database. The database may, in some embodiments, be blockchain-based. The blockchain may include a distributed ledger of electronic data records. Each record may be authenticated by a consensus protocol. A complete copy of the blockchain may be stored on multiple computer systems. Each computer system that stores a copy of the blockchain may be a “node.”

Groups of authenticated transactions may be gathered into “blocks.” Each block may include data and metadata. Metadata may include a reference to the previous block in the chain and a unique identifier associated with the previous block. The unique identifier may be an output of a hash function.

A node may add a block to the blockchain. However, the block may only become part of the blockchain when a quorum—i.e., a predetermined number or percentage—of nodes independently verify and authenticate the transactions set forth in the block. A “consensus” may then be reached to add the block to each copy of the blockchain. Using a blockchain for the platform may leverage the decentralized nature of blockchains to provide transparency and built-in verification in tracking and managing donations in the platform.

The database of the platform may be configured to store a plurality of donations received from a plurality of donors. A donor may be an individual, or, in some embodiments, a donor may be an organization or any other suitable donating entity. The donations may be received via digital transmission, e.g., via an online connection to the platform. The donation may also, in some embodiments, be received in any other suitable way, e.g., in-person, or via other communications such as text message, telephone, or mail.

Each donation may include a monetary value. For example, a donation may include an actual transfer of funds, e.g., cash, check, cryptocurrency, or any other material of value (food, clothing, supplies, etc.). The funds may be stored in a funds account, trust, or any other suitable safekeeping mechanism. A donation may also be a pledge or commitment to donate. The commitment may include a credit card number, bank account number, or any other suitable data to back up a financial commitment. The data may be stored in a secure location, e.g., a secure database. The commitment may include a directive to withdraw funds, using the data, when an appropriate charitable cause is determined.

Each donation may be associated with a target charitable category. A category may, for example, be a broad one, such as “disaster relief.” A category may also be more specific, e.g., “fire relief.” The category may be even more specific, e.g., “fire relief in New York City.” The donor may select the target charitable category for the donation. In some embodiments, the donor may make the selection from closed-ended options (e.g., multiple choice or check boxes) provided to the donor via the platform. In other embodiments, the donor may enter an open-ended description in a provided field.

The platform may also include a plurality of digital portals. Each digital portal may be associated with a donor. For example, a unique portal may be created for each donor. In one particular example, a prospective donor, or a donor who already donated offline, may initiate the set-up of an online account. Logging in to the online account may give the donor access to the digital portal. The donor may be able to donate, and select target charitable categories, via the online account. The digital portal of a donor may be configured to provide the donor with access to the platform. The digital portal may be in the form of a dashboard. The digital portal may include multiple pages and/or multiple options for accessing and performing various tasks on the platform.

The platform may be configured with a hierarchical architecture. The hierarchical architecture may include multiple sets, or tiers, of the digital portals. The multiple tiers may be associated with varying levels of access to the platform. A first tier of digital portals may be configured to provide visibility access. Visibility access may provide access to view data stored in the database. Visibility access may, in some embodiments, provide a flagging mechanism. A flagging mechanism may include the ability to flag a transaction as invalid, e.g., if the target category of the donation and the category of the transaction do not match, or if one of them is misidentified. A flag may disqualify a transaction, trigger an alert for the transaction, freeze the platform from performing all or some other transactions, and/or perform any other suitable response to an invalid transaction.

A second tier of digital portals may be configured to provide authorization access. Authorization access may provide access to authorize transactions on the platform. Each portal may be a part of more than one tier, i.e., a portal may provide visibility access and authorization access.

In some embodiments, each portal may be configured with different levels of access with respect to different donations in the platform. For example, in certain embodiments, every portal may be a part of the first tier, and provide visibility access, for every donation in the platform. However, each portal may be a part of the second tier, and provide authorization access, only with respect to donations of the donor of that portal. In certain embodiments, each donor may be enabled to adjust his level of access by including the portals of other donors to be in the second tier, and have access as a proxy, with respect to the donations of the donor. In certain embodiments, the platform may also be configured to enable a third party to have access as a proxy.

The platform may be further configured to identify a charitable cause. In some embodiments, identifying a charitable cause may be performed automatically via the processor. For example, the processor may scan various news outlets, social media, or other sources of information for notification of an event that may cause a charitable need (e.g., news of a natural disaster, war, tragedy, etc.). The identifying may employ artificial intelligence (“AI”) or machine learning (“ML”) techniques. Identifying a charitable cause may also include receiving a request, from an individual or an entity, for a charitable donation.

The platform may also be configured to determine a monetary amount and a charitable category for association with the charitable cause. This determination may also, in some embodiments, be performed automatically via the processor. The processor may perform an analysis, such as language processing or image recognition, as part of the determination. The platform may also receive some or all of the information as part of a request for charity.

The platform may be configured to structure a transaction. A transaction may include a transfer of funds to a charitable cause. Structuring a transaction may entail setting up the transfer, i.e., allocating select funds to be transferred to a select cause. In some embodiments, the structuring may be performed automatically via the processor.

Structuring a transaction may include compiling a set of donations for the charitable cause. The set of donations may include one or more donations associated with target charitable categories that match the charitable category of the charitable cause. The sum of the monetary values of the one or more donations in the set of donations may equal at least the monetary amount.

The transaction may be authorized via one or more of the second tier of digital portals. In some embodiments of the platform, the authorization may be performed automatically via the processor. The processor may check for a match between the target category and the category of the charitable cause. The processor may also confirm that the amounts of the funds match up to the monetary amount of the cause. The processor may also analyze the records in the database to ensure that the funds are still available, and were not used for other transactions. In certain embodiments, some of these authorizations may be performed manually via the portal.

When the transaction is authorized, the platform may be configured to transfer funds from the one or more donations in the set of donations to the charitable cause. The platform may also be configured to update the database to record the transfer. For example, when the database is implemented as a blockchain, updating the database may include adding a block to the blockchain.

A blockchain database may, in general, include a plurality of nodes. In some embodiments of the platform, the plurality of nodes may include computer systems associated with the plurality of donors. For example, in some embodiments, each donor may be associated with a computer system that is a node. In some cases, the computer system may also provide access for the donor to the digital portal.

In some embodiments, nodes may also include computer systems associated with non-donors, such as a board of trustees or administrators of the donation platform, or any other suitable member of the general public.

In certain embodiments of the platform, the authorization of a transaction may leverage the blockchain database. In these embodiments, the nodes of the blockchain database may include a set of computer systems, wherein each computer system from the set may be associated with one of the second tier of digital portals. The authorization may include a blockchain validation via the blockchain database. The threshold to qualify for the blockchain validation may include a rules-based consensus across the nodes in the blockchain database to authorize the transaction. The rules-based consensus may include predetermined rules for achieving a consensus, such a sufficient number or percentage of systems, and/or a threshold level of confidence, for an authorization.

In some embodiments of the platform, each donation from the plurality of donations may be converted into a plurality of data points. The data points may be stored in the database. Each data point may correspond to a sub-unit of the monetary value of the donation. In some exemplary embodiments, the sub-unit may be equal to $1 United States Dollars (“USD”). In other exemplary embodiments, the sub-unit may be equal to $0.01 USD, or any other suitable sub-unit. In this example, a $1000 donation may be converted into 100,000 data points. One advantage of converting donations into data points may include uniformity across the platform. Once converted into data points, the platform need not be concerned with values, since each data point has the same value. Furthermore, since the donation is split up into small units, such as one cent, the platform may more efficiently allocate an exact portion for one cause, and another exact portion for another cause, until the funds of the donation are fully disbursed.

Some embodiments of the platform may include a third tier of digital portals. The third tier of digital portals may be configured to provide control access. Providing control access may provide access to execute transactions on the platform. Executing a transaction may include structuring the transaction. Executing the transaction may also include triggering a transfer of funds once the transaction is authorized.

Certain embodiments of the platform may include default system settings. Some default system settings may relate to membership of certain digital portals in various tiers of portals. For example, in some embodiments, every digital portal, by a default system setting, may be a member of the first tier of digital portals. Thus every donor may have visibility access for all the donations in the platform.

In some embodiments of the platform, membership of a digital portal in the first, second and/or third tier of digital portals may be subject to a selection by the donor associated with that digital portal. For example, each portal may include selectable options for setting a level of access of the portal to the platform. The selectable options may be for one, some, or all of the donations in the platform.

In certain embodiments of the platform, a digital portal may be a member of one tier with respect to some data points (or, alternatively, donations), and other tiers with respect to other data points. For example, a digital portal may be in the first tier, and provide visibility access, for some (or all) the data points in the platform. The same digital portal may be part of the second and/or third tiers, and provide authorization and/or control access, for other data points in the platform. In one particular example, each digital portal, by a default system setting, may be a member of the second tier of digital portals—thereby providing authorization access—only with respect to the donations of the donor associated with the digital portal.

In some embodiments, the platform may be further configured to enable a donor to adjust a level of authorization and control over data points from his or her own donations. A donor may wish to adjust the levels of authorization and control if, for example, the donor does not have the time or expertise to manage his or her own donations. The adjusting may include presenting a selectable option via the digital portals of one or more other donors, thereby providing them the option of becoming proxies on the donations. A selection of the selectable option by one of the other donors may configure the digital portal of the other donor to join the second and/or third tiers of digital portals with respect to the donations.

In certain embodiments of the platform, membership of a digital portal in the second and/or third tiers of digital portals may be subject to a blockchain validation. For example, nodes with portals that have authorization access for a certain data point may be able to validate, via a consensus, the inclusion of another node. In this embodiment, the set of “voting nodes” that contribute to a consensus may vary from one validation to the next within the blockchain. In another embodiment, every node in the platform may be a “voting node” for every validation.

Some embodiments of the platform may provide end-to-end management and tracking. In some scenarios, a charitable cause may be an individual. Transferring the funds to the individual may include a disbursement of much needed cash, food, or supplies. Thus, a donor may, via the platform, be able to manage and track the flow of funds from his or her donation all the way until the funds provide actual relief.

In some embodiments, the platform may provide end-to-end tracking even when the charitable cause is an organization. For example, the donor may donate to the platform and the donation may be recorded on the database, e.g., a blockchain. The platform may route the funds to an organization according to the disclosed systems and methods, recording the transfer to the blockchain. The organization may then disburse the funds to an individual in need, and the disbursement may also be recorded on the blockchain. In some embodiments, disbursements of funds may be validated and recorded by storing photo and/or video records of the disbursement on the database, e.g., the blockchain. The donor may thereby be provided with complete end-to-end tracking of the flow of his or her funds until they actually reach the possession of an individual in need.

It is further envisioned that the platform may, in certain embodiments, be configured to provide scheduling functionality. For example, the platform may be configured to enable one charity to “borrow” from another for a set time. A list of high-need charities may be sent to users to gauge interest in moving part or all their funding to a secondary charity. The users may be enabled to decline, and/or add separate funds for the in-need charities.

A method for tracking and controlling the flow of funds in a digital donation platform is provided. The method may be executed by computer code stored in a non-transitory memory and running on a processor. The method may include receiving a plurality of donation transmissions from a plurality of donors. Each donation transmission may include a monetary value and may be associated with one or more target charitable categories. The target charitable categories may be selected by the donor of the donation transmission.

The method may include converting each donation transmission into a plurality of data points. Each data point of a donation transmission may correspond to a sub-unit of the monetary value of the donation transmission. In some embodiments, the sub-unit may be equal to either 1 or 0.01 United States Dollars, or any other suitable value.

The method may include storing the pluralities of data points on a database. The method may also include configuring the database with a portal for each donor. The portal of a donor may be configured to enable the donor access to the database. Each portal may be configured with an access profile. An access profile may define a permission status for each of various categories.

Categories in an access profile may include visibility, authorization, and control. A portal with visibility permission for a data point may be configured to enable access to metadata associated with the data point. The metadata may include the target charitable categories associated with the data point. A portal with authorization permission for a data point may be configured to enable authorization for a transaction involving said data point. A portal with control permission for a data point may be configured to enable arrangement of a transaction involving the data point.

The method may include identifying a charitable cause. The method may also include determining a monetary amount and a charitable category for the charitable cause.

The method may include compiling a set of qualifying data points. The set of qualifying data points may represent funds to be donated to the charitable cause. Compiling the set of qualifying data points may be achieved by searching the database for data points that are associated with a target charitable category that matches the charitable category of the charitable cause. The method may also include adjusting the set of qualifying data points to include an appropriate number of data points. An appropriate number may be a selected such that the sum of the corresponding monetary values of the number of data points equals the monetary amount of the charitable cause. In some embodiments, compiling the set of qualifying data points may be executed via one or more portals with control permission.

The data points in the set of qualifying data points may be authorized, e.g., via one or more portals with authorization permissions. When the data points are authorized, the method may include transferring the monetary amount to the charitable cause. The method may also include updating the database to record the transfer.

In certain embodiments of the method, the database may be configured as a blockchain. The blockchain may include a plurality of nodes. The plurality of nodes may include a set of computer systems. Each computer system may, in certain embodiments, be associated with a donor with authorization permission.

The method may further include leveraging the blockchain for authorizing the qualifying data points. Leveraging the blockchain may include a blockchain validation for the authorization. At least a part of the threshold to qualify for the blockchain validation in the blockchain database may include attaining a rules-based consensus across the plurality of nodes to authorize the transaction.

Some embodiments of the method may include configuring the platform with default system settings. For example, each portal may, by default, have authorization and control permissions for the data points of a donor's own donations. The method may further include configuring the platform to enable a donor to extend permissions for their own donations to other, proxy, donors. For example, a first donor may be able, via their portal, to scale a level of authorization and control by presenting a selectable option to other donors via their respective portals. A selection of the option may configure the other portals with authorization and/or control permissions with respect to some or all of the data points of the donations of the first donor.

A charitable donation platform is provided. The platform may include computer executable code stored in a non-transitory memory that, when run on a processor, may be configured to execute features of the platform. The platform may include a blockchain database.

The platform may be configured to receive a plurality of donation transmissions from a plurality of donors. Each donation transmission may include a monetary value and may be associated with one or more target charitable categories. The target charitable categories may be selected by the donor of the donation transmission.

The platform may be configured to convert each donation transmission into a plurality of data points. Each data point of a donation transmission may correspond to a sub-unit of the monetary value of the donation transmission. For example, the sub-unit may be equal to either 1 or 0.01 United States Dollars, or any other suitable amount. The platform may be configured to store the pluralities of data points on the blockchain database.

The blockchain database may be configured with a portal for each donor. The portal of a donor may be configured to provide the donor access to the blockchain database. Each portal may be configured with an access profile that defines a permission status for each of various categories.

Categories may include visibility, authorization, and control. A portal with visibility permission for a data point may enable access to view metadata associated with the data point. The metadata may include the target charitable categories associated with the data point. A portal with authorization permission for a data point may enable access to authorize a transaction involving the data point. A portal with control permission for a data point may enable access to execute a transaction involving the data point.

The platform may be configured to identify a charitable cause. The platform may also be configured to determine a monetary amount and a charitable category for the charitable cause.

The platform may also be configured to compile a set of qualifying data points. In some embodiments, one or more portals with control permission may be configured to compile the set of qualifying data points. The set of qualifying data points may represent funds to be donated to the charitable cause. The platform may compile the set by searching the blockchain database for data points that are associated with a target charitable category that matches the charitable category of the charitable cause. The platform may be configured to adjust the set of qualifying data points to include a specific number of data points. The specific number of data points may be a number such that the sum of the monetary values of the corresponding donations equals the monetary amount of the charitable cause.

The platform may include an authorization prerequisite for a transfer of funds. For example, when each data point in the set of qualifying data points is authorized via one or more portals with authorization permissions, the platform may be configured to transfer the monetary amount to the charitable cause. The platform may be configured to update the blockchain database to record the transfer.

In some embodiments of the platform, the authorization of a transaction leverages the blockchain database. The authorization may include a blockchain validation. At least a part of the threshold to qualify for the blockchain validation in the blockchain database may include a rules-based consensus across a plurality of nodes—e.g., a set of computer systems, wherein each computer system may be associated with a portal with authorization permission—to authorize the transaction.

Some embodiments of the platform may be configured with default system settings. For example, each portal may, by default, have authorization and control permissions for the data points of a donor's own donations. The platform may be further configured to enable a donor to extend permissions for their own donations to other, proxy, donors. For example, a first donor may be able, via their portal, to scale a level of authorization and control by presenting a selectable option to other donors via their respective portals. A selection of the option may configure the other portals with authorization and/or control permissions with respect to some or all of the data points of the donations of the first donor.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

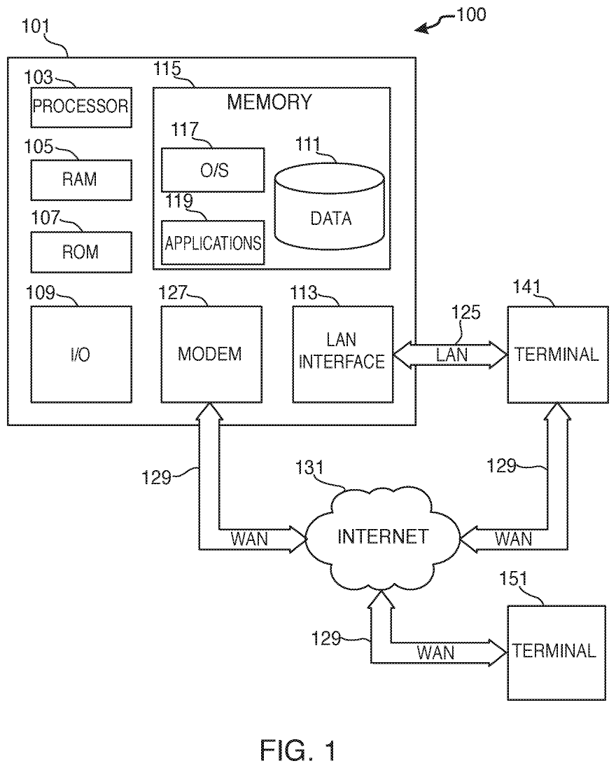

FIG. 1 shows an illustrative block diagram of system 100 that includes computer 101. Computer 101 may alternatively be referred to herein as a “server” or a “computing device.” Computer 101 may be a desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may relate to transmitting, tracking, authorizing, and/or controlling charitable donations. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server.

The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory. The transmission of the data together with computer-readable instructions may enable the computer system to quickly retrieve the data, when needed. Because the computer system is able to quickly retrieve the data, the web-based server may not need to stream the data to the computer system. This may be beneficial for the computer system, because the retrieval may be faster than data-streaming. Conventionally, streaming data requires heavy usage of the processor and the cache memory. If the data is stored in the computer system's memory, retrieval of the data may not require heavy processor and cache memory usage. Any of various conventional web browsers can be used to display and manipulate retrieved data on web pages.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related performing various tasks. The various tasks may be related to transmitting, tracking, authorizing, and/or controlling charitable donations.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry™, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

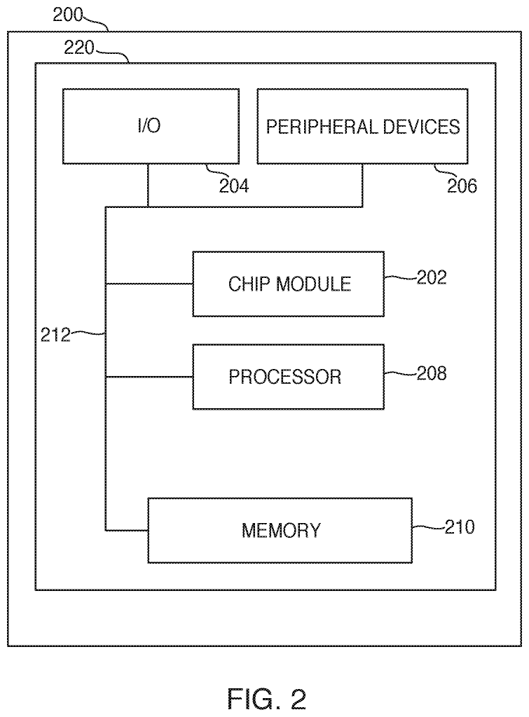

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

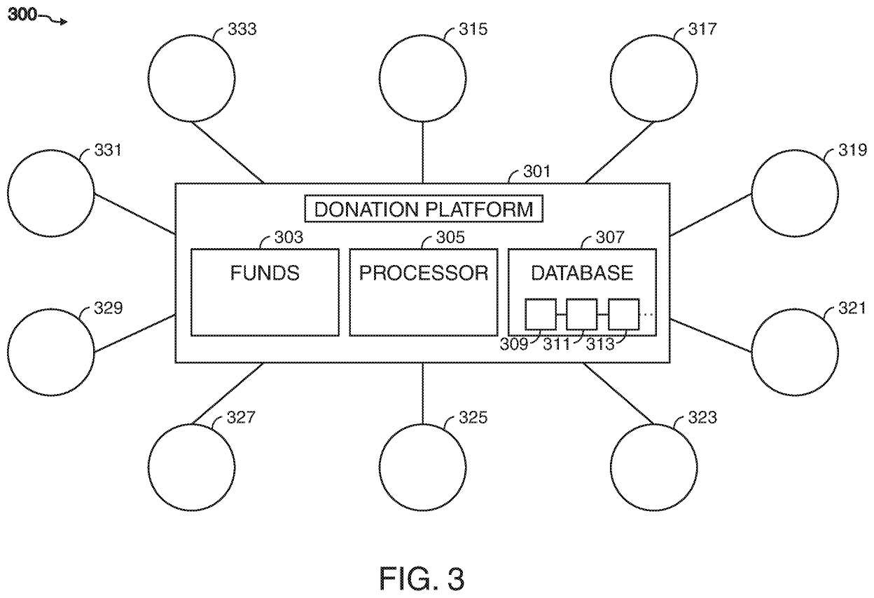

FIG. 3 shows an architectural diagram of illustrative system 300 according to aspects of the disclosure. System 300 may include donation platform 301. Donation platform 301 may include a funds module 303, a processor 305, and a database 307.

Funds module 303 may be any suitable module for storing funds—or other items of value—received from donation transmissions. For example, funds module 303 may be an account at a financial institution. Funds module 303 may be a database for storing account or payment instrument information. Funds module 303 may also include a safe, warehouse, or other storage facility suitable for storing items of value.

Database 307 may be any suitable database for storing donation data. In some embodiments, database 307 may be implemented as a blockchain, including blocks 309-313.

System 300 may include portals 315-333. Each portal may be associated with a donor, and may provide the donor access to the platform. Furthermore, each portal may be configured with an access profile defining a level of access to the platform. Each portal may have a different access profile for each donation or data point in the platform.

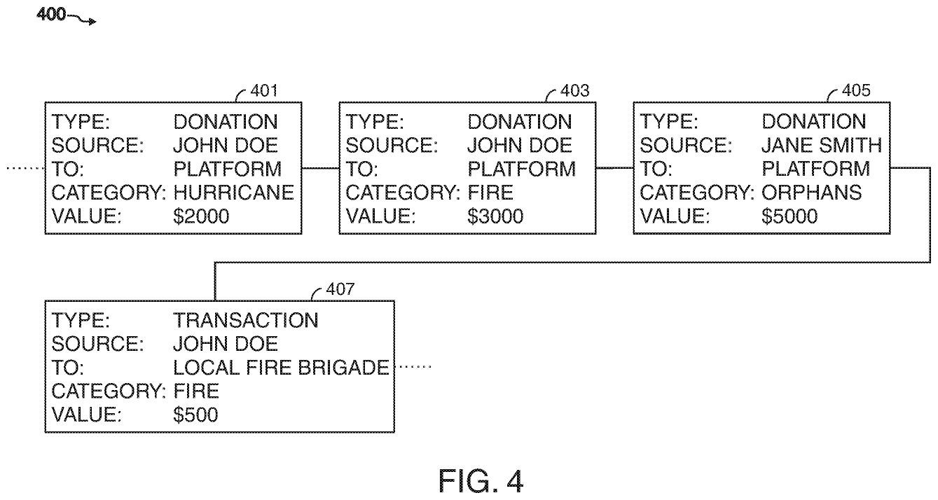

FIG. 4 shows illustrative diagram 400 of an exemplary database according to aspects of the disclosure. Diagram 400 shows blocks 401-407 that may form part of a blockchain.

In one exemplary embodiment, each block in the blockchain may contain the data from a single donation or transaction (i.e., a transfer of funds). Each block may, in some embodiments, feature the same data fields. For example, each block may include a data field for “type,” “source,” “to,” “category,” and “value.”

The “type” data field may indicate whether the block represents a donation or a transaction. The “source” data field may indicate the name and/or other identifying data (e.g., a unique donor number) of the donor. In the case of a donation, this refers to the donor of the donation. In the case of a transaction, this may refer to the donor of the funds that are being transferred in the transaction. The “to” field may indicate the destination of the funds. In the case of a donation, the destination may generally be the platform (or, alternatively, the field may be left blank). In the case of a transaction, the destination may be the charitable cause to which the funds are being transferred. The “category” field may indicate the target charitable category in the case of a donation, and the actual charitable category determined by the platform for the charitable cause in the case of a transaction. The “value” field may indicate a monetary value associated with the donation or the value of funds transferred in a transaction. Other metadata, such as a timestamp, a type of donated funds (and how to access them), or any other suitable metadata, may also be recorded.

For example, block 401 may record a donation from John Doe of $2000 for hurricane-related causes. Block 403 may record a donation from John Doe of $3000 for fire-related causes. The donations of block 401 and 403 may have been donated at different times. Alternatively, the donations of block 401 and 403 may have been part of the same $5000 donation, and John Doe may have selected “hurricane” as a target category for $2000 and “fire” as the target category for $3000. In such instances, where a single donation is split into parts associated with different target categories, the platform may, in some embodiments, record each part as a different block.

Block 405 may show a record of a donation from Jane Smith of $5000 for orphan-related causes. Block 407 may record a transaction transferring $500 of John Doe's funds to the local fire brigade. The transaction of block 407 may be responsive to a determination that the local fire brigade needs $500. The determination may be based on a news report, an advertisement, a request, information retrieved from social media, or any other suitable source of information. In some embodiments, the determined need may be stored in other memory of the platform. In other embodiments, the determined need may also be stored on the blockchain. In still other embodiments, the determined need may only be stored until the need is satisfied with a transfer of funds.

In certain embodiments, some or all of the data in the database may be at least partially masked. For example, the platform may include an anonymizing agent that masks the identity of a donor and/or a charitable cause. The platform may instead show a tokenized id or pseudo name. When the identities are masked, the database may be shared while maintaining safety and privacy. The masking could extend throughout successive stages of the donation process, providing end-to-end safety and privacy. Further utilizing a masking feature, a contributor (i.e., a donor) to the platform or an administrator of the platform may be enabled to share their data with another contributor or platform. If the other contributor or platform are associated with a higher priority, the sharing may automatically shift the data to the higher priority.

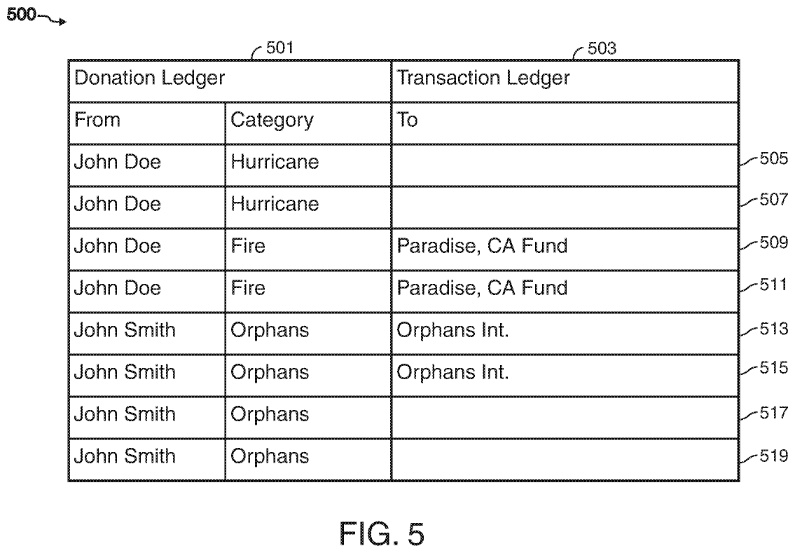

FIG. 5 shows illustrative diagram 500 of an exemplary database according to aspects of the disclosure. Diagram 500 shows ledgers 501 and 503. Each of the ledgers 501 and 503 may include data rows 505-519. Ledgers 501 and 503 may, in some embodiments, form part of a blockchain.

Ledger 501 may be a donation ledger storing information about donations to the platform. Each row of the ledger may record a donation, or a part of a donation that has a unique target category. In some embodiments, each row may represent one data point. For example, a $2000 donation may be converted into 200,000 one-cent data points. Each row may represent one data point, and may therefore have an implicit value that does not need to be stored explicitly.

Ledger 503 may be a transaction ledger storing information about transactions of the platform. Each row of the ledger may record a transaction. In some embodiments, each row may represent one data point of a transaction. For example, a $2000 transaction may be converted into 200,000 one-cent data points. Each row may represent one data point, and may therefore have an implicit value that does not need to be stored explicitly. When the funds associated with a data point are transferred in a transaction, the transfer may be recorded in a row of transaction ledger 503 that corresponds to the row of the data point in donation ledger 501. Therefore, when structuring a transaction, the platform may search for an appropriate data point that has an empty row in transaction ledger 503, indicating that the data point is available.

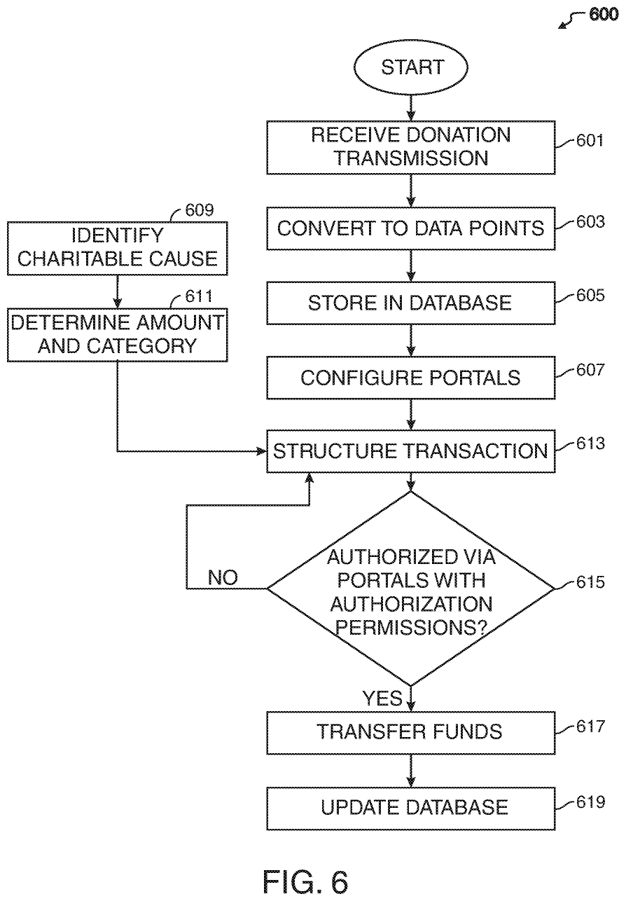

FIG. 6 shows flowchart 600 depicting the logical flow of an exemplary embodiment according to aspects of the disclosure. Other embodiments may include different steps, and/or different step sequences.

Flowchart 600 starts with step 601, receiving a donation transmission. At step 603, the donation transmission may be converted into data points. The data points may be stored in a data base at step 605. At step 607, the portals may be configured with access profiles for those data points.

At step 609, a charitable cause may be identified. At step 611, a monetary amount and a charitable category may be determined for the charitable cause. At step 613, a transaction may be structured. The transaction may be structured based on the charitable causes that have been identified, as well as the data points in the data base. Step 615 may query if the transaction has been authorized by portals with authorization permissions. If the transaction has not been authorized, step 613 may be revisited, and a different transaction may be structured. If a transaction is authorized, funds may be transferred at step 617 and the database may be updated at 619 to record the transfer.

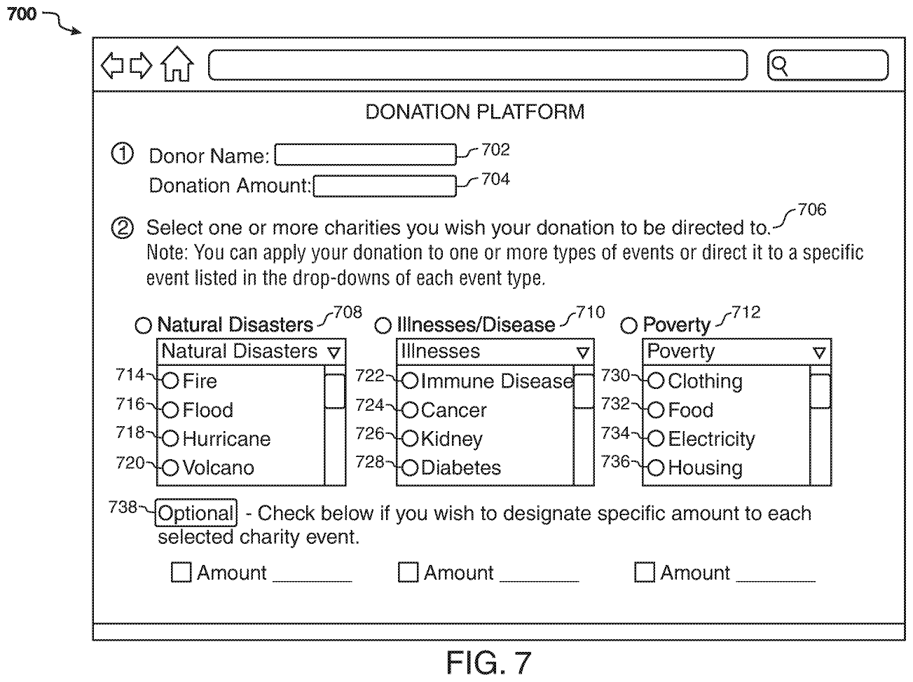

FIG. 7 shows a screenshot of an illustrative graphical user interface (“GUI”) 700 for a digital donation platform. The digital donation platform may incorporate features included and/or similar to those disclosed in co-pending U.S. patent application Ser. No. 16/276,694 entitled “DONOR AND RECIPIENT AUTHENTIC AUTHORIZATION,” the contents of which have been incorporated herein by reference.

GUI 700 may be part of a digital portal, e.g., an online account. The digital donation platform may be associated with an entity that accepts donations for a plurality of organizations and/or causes. GUI 700 may enable a donor to submit a donation and select a target organization and/or category to which the donor would like the donation directed.

At step number one, a donor name may be entered at text-box 702. The donation amount may be entered at text-box 704. At step number two 706, the donor may be enabled to select one or more target charities. GUI 700 may display three different types of events. The digital donation platform may include many more target categories not shown in this exemplary GUI. The digital donation platform may also include a list of specific charity organizations that can be selected as opposed to a type of charity and/or a type of event. The digital donation platform may also include a field where the donor is able to submit an open-ended description of the target categories.

GUI 700 displays an option for a selection of an event-type associated with natural disasters, as shown at 708. The natural disasters option 708 may also include a drop-down menu of specific types of natural disasters. The donor may select only the natural disaster option. The donor may select a specific natural disaster. The specific natural disasters listed, but are not limited to, are a fire 714, a flood 716, a hurricane 718 and a volcano 720. GUI 700 further displays an option for a selection of an event-type associated with illnesses and diseases, as shown at 710. The illnesses/disease option 710 may also include a drop-down menu of specific types of illnesses and diseases. The donor may select only the illness/disease option. The donor may select a specific illness/disease. The specific illnesses/diseases listed, but are not limited to, are immune disorder 722, cancer 724, kidney 726 and diabetes 728.

GUI 700 further displays an option for a selection of an event-type associated with poverty, as shown at 712. The poverty option 712 may also include a drop-down menu of specific types needs associated with poverty. The donor may select only the poverty option. The donor may select a specific type of need associated with poverty. The specific poverty types of needs listed, but are not limited to, are clothing 730, food 732, electricity 734 and housing 736.

The donor may be enabled to divide the donation amount. The donor may be able to designate specific portions of the donation to specific events. Option 738 may display the option. A specific amount may be entered for each event that may be selected by the donor. The data entered in GUI 700 may be saved in the system. The data may be processed by a processor of the system and may be recorded within a blockchain. Data inputted by the donor may be part of the metadata included in each data point for each sub-asset, or sub-unit, created for the received donation.

The GUI may further include, but may not be shown on GUI 700, a list of specific charity organizations to which a donor may direct funds. The donor may select one or more specific charity organizations that may be potential recipients of the donation and/or may substantially instantaneously receive the donor's funds at the time of the donation.

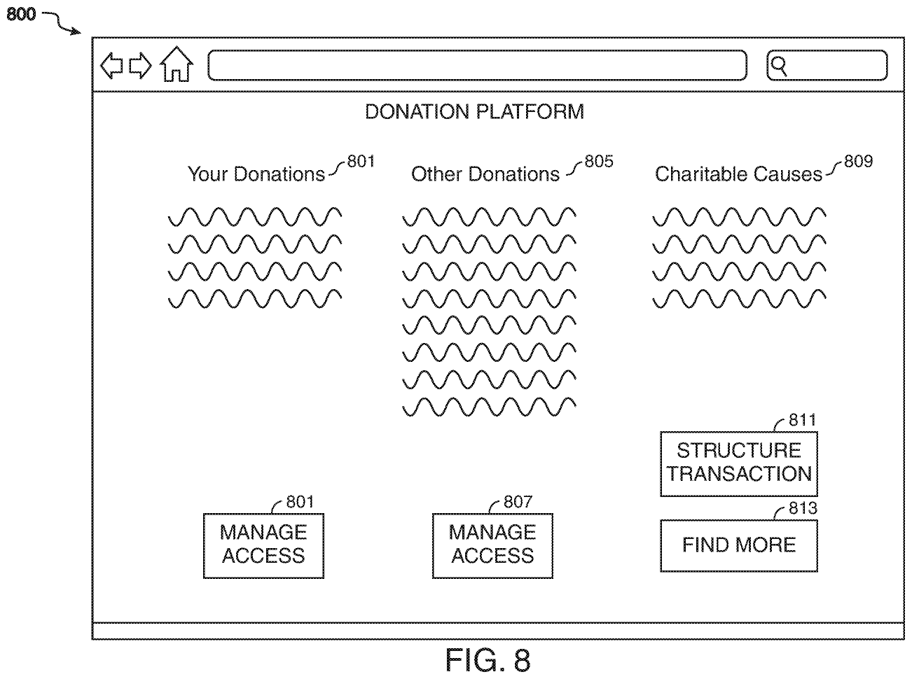

FIG. 8 shows a screenshot of an illustrative graphical user interface (“GUI”) 800 for a digital donation platform. GUI 800 may be part of the same, or similar, digital donation platform as GUI 700 shown in FIG. 7 above. GUI 800 may show a screen providing access to donations on the platform.

Portion 801 may show a list of the donor's own donations. Metadata associated with the donations, including value, category, and any transactions involving the donations, may be displayed as well. Button 803 may provide access to manage the donations of portion 801. Managing the donations may include tracking the donations, and structuring, authorizing, and/or executing transactions with the donations.

Portion 805 may show a list of other donations in the platform. In some embodiments, this may include all the other donations in the platform. In other embodiments, this may include only those donations whose donors expressly enabled this portal to have visibility access. In still other embodiments, some of the donations may indicate that they are configured with control access. For example, the donations with control access may be selectable. Button 807 may provide access to manage the donations of portion 805.

Portion 809 may show a list of identified charitable causes. The platform may show other information associated with each charitable cause, such as an amount and a category. Button 811 may provide access to structure transactions and/or transmit donations to the charitable causes. Button 813 may provide access to find more charitable causes.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and apparatus for hierarchical proxy power systems for administration of charitable trust are provided. Persons skilled in the art will appreciate that the present invention can be practiced by other than the described embodiments, which are presented for purposes of illustration rather than of limitation, and that the present invention is limited only by the claims that follow.

What is claimed is:

1. A charitable donation platform, said platform comprising:
a blockchain database configured to store a plurality of donations received from a plurality of donors, each donation comprising a monetary value and associated with a target charitable category selected by the donor of said donation; and
a plurality of digital portals, each digital portal associated with a donor, the digital portal of a donor configured to provide said donor access to the platform;
wherein:
the platform is configured with a hierarchical architecture wherein:
a first tier of digital portals are configured to provide visibility access, said visibility access that provides access to view data stored in the blockchain database; and
a second tier of digital portals are configured to provide authorization access, said authorization access that provides access to authorize transactions on the platform; and
the platform is further configured to:
identify a charitable cause;
determine a monetary amount and a charitable category for association with the charitable cause;
structure a transaction by compiling a set of donations for the charitable cause, said set of donations comprising one or more donations associated with target charitable categories that match the charitable category of the charitable cause, and wherein the sum of the monetary values of the one or more donations in the set of donations equals at least the monetary amount; and
when the transaction is authorized via one or more of the second tier of digital portals:
transfer funds from the one or more donations in the set of donations to the charitable cause; and
update the blockchain database to record the transfer.

2. The platform of claim 1, wherein the blockchain database comprises a plurality of nodes, and wherein the plurality of nodes comprise computer systems associated with the plurality of donors.

3. The platform of claim 1, wherein the authorization of a transaction leverages the blockchain database, said authorization comprising a blockchain validation, wherein:
the blockchain database comprises a plurality of nodes, and the plurality of nodes comprise a set of computer systems, wherein each computer system from the set of computer systems is associated with a digital portal from the second tier of digital portals; and
at least a part of the threshold to qualify for the blockchain validation in the blockchain database comprises a rules-based consensus across the plurality of nodes to authorize the transaction.

4. The platform of claim 1, wherein:
each donation from the plurality of donations is converted into a plurality of data points, each data point corresponding to a sub-unit of the monetary value of said donation, wherein the sub-unit is equal to either 1 or 0.01 United States Dollars; and
the data points are stored in the blockchain database.

5. The platform of claim 1, further comprising a third tier of digital portals that are configured to provide control access, said control access that provides access to execute transactions on the platform, wherein the structuring a transaction is performed either automatically or via at least one of the third tier of digital portals.

6. The platform of claim 1, wherein every digital portal is, by a default system setting, a member of the first tier of digital portals.

7. The platform of claim 1, wherein membership of a digital portal in the first and/or second tier of digital portals is subject to a selection by the donor associated with said digital portal.

8. The platform of claim 1, wherein each digital portal is, by a default system setting, a member of the second tier of digital portals with respect to the donations of the donor associated with said digital portal, and the platform is further configured to enable said donor to adjust a level of authorization and control by presenting a selectable option via the digital portals of one or more other donors, said selectable option to configure said digital portals to join the second tier of digital portals with respect to said donations of the donor.

9. The platform of claim 1, wherein membership of a digital portal in the first and/or second tier of digital portals is subject to a blockchain validation via the blockchain database.

10. A method for tracking and controlling the flow of funds in a digital donation platform, the method executed by computer code stored in a non-transitory memory and running on a processor, the method comprising:
receiving a plurality of donation transmissions from a plurality of donors, each donation transmission comprising a monetary value and associated with one or more target charitable categories selected by the donor of said donation transmission;
converting each donation transmission into a plurality of data points, each data point of a donation transmission corresponding to a sub-unit of the monetary value of said donation transmission;
storing the pluralities of data points on a database;
configuring the database with a portal for each donor, wherein the portal of a donor is configured to enable access for the donor to the database, and each portal is configured with an access profile, said access profile comprising a permission status for visibility, authorization, and control, wherein:
a portal with visibility permission for a data point is configured to enable access to metadata associated with said data point, said metadata comprising the one or more target charitable categories associated with the data point;
a portal with authorization permission for a data point is configured to enable authorization for a transaction involving said data point; and
a portal with control permission for a data point is configured to enable arrangement of a transaction involving said data point;
identifying a charitable cause;
determining a monetary amount and a charitable category for the charitable cause;
compiling a set of qualifying data points by searching the database for data points that are associated with a target charitable category that matches the charitable category of the charitable cause;
adjusting the set of qualifying data points to comprise a number of data points wherein the sum of the corresponding monetary values of the number of data points equals the monetary amount of the charitable cause; and
when each data point in the set of qualifying data points is authorized via one or more portals with authorization permissions:
transferring the monetary amount to the charitable cause; and
updating the database to record the transfer.

11. The method of claim 10, wherein the database is configured as a blockchain.

12. The method of claim 11, wherein the blockchain comprises a plurality of nodes, and the plurality of nodes comprise a set of computer systems, wherein each computer system from the set of computer systems is associated with a donor with authorization permission, and the method further comprises:
leveraging the blockchain for authorizing the qualifying data points by including a blockchain validation for the authorization, wherein at least a part of the threshold to qualify for the blockchain validation in the blockchain database comprises attaining a rules-based consensus across the plurality of nodes to authorize the transaction.

13. The method of claim 10, wherein the sub-unit is equal to either 1 or 0.01 United States Dollars.

14. The method of claim 10, wherein the compiling the set of qualifying data points is executed via one or more portals with control permission.

15. The method of claim 10, wherein each portal, by a default system setting, has authorization and control permissions for the data points of the donations of the donor of said portal, and the method further comprises enabling said portal to scale a level of authorization and control by presenting one or more other portals with a selectable option, wherein selecting said option configures said one or more other portals with authorization and/or control permissions with respect to some or all of the data points of said donations of the donor.

16. A charitable donation platform, said platform comprising a blockchain database and computer executable code stored in a non-transitory memory that, when run on a processor, is configured to:
receive a plurality of donation transmissions from a plurality of donors, each donation transmission comprising a monetary value and associated with one or more target charitable categories selected by the donor of said donation transmission;
convert each donation transmission into a plurality of data points, each data point of a donation transmission corresponding to a sub-unit of the monetary value of said donation transmission;
store the pluralities of data points on the blockchain database;
configure the blockchain database with a portal for each donor, wherein the portal of a donor is configured to enable access for the donor to the blockchain database, and each portal is configured with an access profile, said access profile comprising a permission status for visibility, authorization, and control, wherein:
a portal with visibility permission for a data point enables access to view metadata associated with said data point, said metadata comprising the one or more target charitable categories associated with the data point;
a portal with authorization permission for a data point enables access to authorize a transaction involving said data point; and
a portal with control permission for a data point enables access to execute a transaction involving said data point;
identify a charitable cause;
determine a monetary amount and a charitable category for the charitable cause;
compile a set of qualifying data points by searching the blockchain database for data points that are associated with a target charitable category that matches the charitable category of the charitable cause;
adjust the set of qualifying data points to comprise a number of data points wherein the sum of the corresponding monetary values of the number of data points equals the monetary amount of the charitable cause; and
when each data point in the set of qualifying data points is authorized via one or more portals with authorization permissions:
transfer the monetary amount to the charitable cause; and
update the blockchain database to record the transfer.

17. The platform of claim 16, wherein the authorization of a transaction leverages the blockchain database, said authorization comprising a blockchain validation, wherein:
the blockchain database comprises nodes, the nodes comprising a set of computer systems, wherein each computer system from the set of computer systems is associated with a portal with authorization permission; and
at least a part of the threshold to qualify for the blockchain validation in the blockchain database comprises a rules-based consensus across the plurality of nodes to authorize the transaction.

18. The platform of claim 16, wherein the sub-unit is equal to either 1 or 0.01 United States Dollars.

19. The platform of claim 16, wherein one or more portals with control permission are configured to compile the set of qualifying data points.

20. The platform of claim 16, wherein each portal, by a default system setting, has authorization and control permissions for the data points of the donations of the donor of said portal, and said portal is further configured to scale a level of authorization and control by presenting, via one or more other portals, a selectable option for said one or more other portals to have authorization and/or control permissions with respect to some or all of the data points of said donations of the donor.
